(19) United States
(12) Patent Application Publication
(10) Pub. No.: US 2014/0319930 A1
(43) Pub. Date: Oct. 30, 2014

(54) POWER SUPPLY CIRCUIT

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: SONG-LIN TONG, Shenzhen (CN); XI-RONG PENG, Shenzhen (CN)

(73) Assignees: HONG FU JIN PRECISION INDUSTRY (ShenZhen) CO., LTD, Shenzhen (CN); HON HAI PRECISION INDUSTRY CO., LTD., New Taipei (TW)

(21) Appl. No.: 14/258,188

(22) Filed: Apr. 22, 2014

(30) Foreign Application Priority Data
Apr. 29, 2013 (CN) 201310155070X

(51) Int. Cl. H01R 13/648

(52) U.S. Cl. CPC H01R 13/648
USPC 307/116

(57) ABSTRACT

A power supply circuit which ceases the supply of power to an external device if the ground connection of the external device is broken includes a connector module, a test module, and a switch module. The connector module connects to the external device. The test module tests the connection between the connector module and the external device and can output a first or a second signal. The switch module is connected between the test module and the connector module, when the switch module receives the first signal from the test module, the switch module permits a connection between the connector module and power supply. When the switch module receives the second signal from the test module, the switch module disconnects the connector module from the power supply.

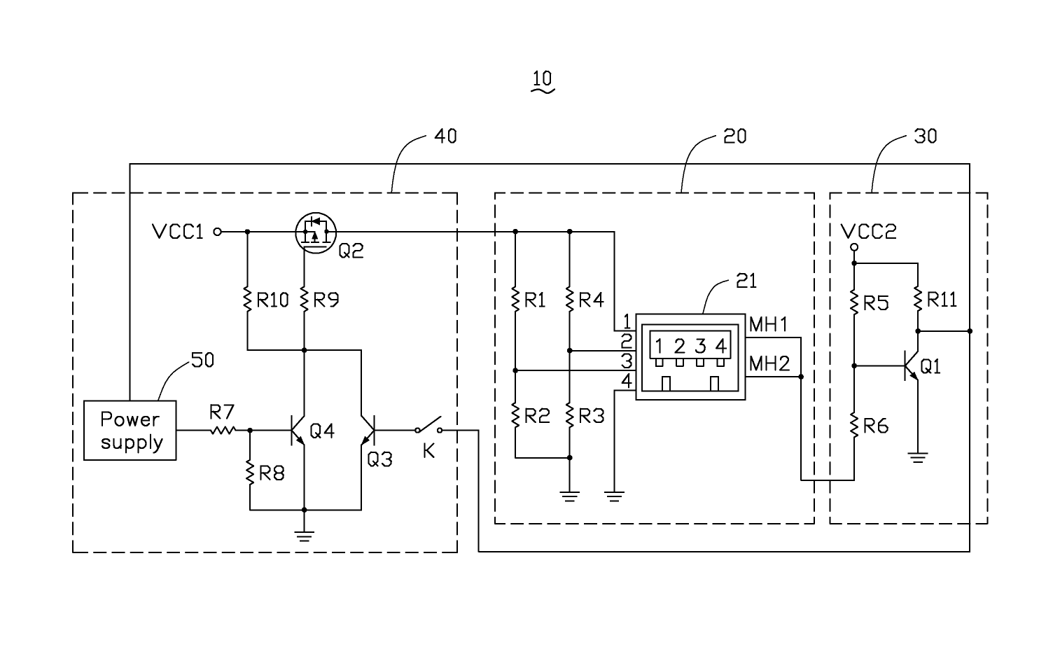

### FIELD

The present disclosure relates to power supply circuits.

### BACKGROUND

A portable device is charged through a universal serial bus (USB) connector. When a ground pin of the portable device is not actually grounded, a current from the USB connector may damage the portable device.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure.

The FIGURE is a circuit diagram of an embodiment of a power supply circuit of the present disclosure.

### DETAILED DESCRIPTION

The disclosure is illustrated by way of example and not by way of limitation in the FIGURE of the accompanying drawing. It should be noted that references to “an” or “one” embodiment in this disclosure are not necessarily to the same embodiment, and such references mean “at least one.” The reference “a plurality of” means “at least two.”

The FIGURE shows an embodiment of a power supply circuit 10 of the present disclosure.

The power supply circuit 10 may comprises a connector module 20, a test module 30, and a switch module 40.

The connector module 20 can comprise resistors R1-R4 and a universal serial bus (USB) connector 21. The USB connector 21 can comprise pins 1-4, a first shield pin MH1, and a second shield pin MH2. The pin 1 is connected to a power input VCC1 through the switch module 40. The pin 2 is connected to the power input VCC1 through the resistor R4. The pin 2 is also grounded through the resistor R3. The pin 3 is connected to the power input VCC1 through the resistor R1. The pin 3 is also grounded through the resistor R2. The pin 4 is grounded. The first shield pin MH1 and the second shield pin MH2 are connected to the test module 30. When the USB connector 21 is not connected to an external device, the first shield pin MH1 and the second shield pin MH2 are floating. When the USB connector 21 is connected to the external device, the first shield pin MH1 and the second shield pin MH2 are grounded.

The test module 30 can comprise a resistor R5, a resistor R6, a resistor R11, and an electronic switch Q1. A power input VCC2 is connected to the first shield pin MH1 through the resistor R5 and the resistor R6 in that order. A node between the resistor R5 and the resistor R6 is connected to a first terminal of the electronic switch Q1. The power input VCC2 is connected to a second terminal of the electronic switch Q1. The second terminal of the electronic switch Q1 is connected to the switch module 40. A third terminal of the electronic switch Q1 is grounded.

The switch module 40 can comprise resistors R7 through R10, electronic switches Q2 through Q4, a standby switch K, and a power supply 50. The power input VCC1 is connected to a second terminal of the electronic switch Q2. The power input VCC1 is also connected to a second terminal of the electronic switch Q4 through the resistor R10. The second terminal of the electronic switch Q4 is connected to the first terminal of the electronic switch Q2 through the resistor R9. A third terminal of the electronic switch Q2 is connected to the pin 1 of the USB connector 21. A third terminal of the electronic switch Q4 is grounded. A first terminal of the electronic switch Q4 is connected to an output of the power supply 50 through the resistor R7. The first terminal of the electronic switch Q4 is grounded through the resistor R8. An input of the power supply 50 is connected to the second terminal of the electronic switch Q1. A first terminal of the electronic switch Q3 is connected to the second terminal of the electronic switch Q1 through the standby switch K. A second terminal of the electronic switch Q34 is connected to the second terminal of the electronic switch Q4. A third terminal of the electronic switch Q3 is grounded.

In the embodiment, a motherboard supplies voltage of 5V through the power input VCC1 and the power input VCC2. A resistance of the resistor R5 is 100K ohm. A resistance of the resistor R11 is 100K ohm. A resistance of the resistor R6 is 1K ohm. The electronic switches Q1, Q3, and Q4 are n-channel Bipolar Junction Transistors (BJTs). First terminals of the respective electronic switches are bases of the BJTs. Second terminals of the respective electronic switches are collectors of the BJTs. Third terminals of the respective electronic switches are emitters of the BJTs. The electronic switch QA2 is a p-channel field effect transistor (FET). The first terminal of the electronic switch Q2 is a gate of the FET. The second terminal of the electronic switch Q2 is a source of the FET. The third terminal of the electronic switch Q2 is a drain of the FET. In this embodiment, a voltage not greater than 0.5V is logic-low for the electronic switches, and a voltage greater than 0.5 is logic-high for the electronic switches.

When the USB connector 21 is connected to the external device, the first shield pin MH1 and the second shield pin MH2 are grounded. The power input VCC2 is grounded through the resistor R5 and the resistor R6 in that order. The node between the resistor R5 and the resistor R6 is at logic low. The electronic switch Q1 is turned off. The input of the power supply 50 is at logic high. The power supply 50 outputs a logic-high signal to the first terminal of the electronic switch Q4 through the resistor R7. The electronic switch Q4 is turned on. A first terminal of the electronic switch Q2 is at logic low. The electronic switch Q2 is turned on. The power input VCC1 supplies power for the USB connector 21 through the electronic switch Q2.

When the USB connector 21 is not connected to an external device, the first shield pin MH1 and the second shield pin MH2 are floating. The first terminal of the electronic switch Q1 is at logic high. The electronic switch Q1 is turned on. The input of the power supply 50 is at logic low. The power supply 50 outputs a logic-low signal to the first terminal of the electronic switch Q4. The electronic switch Q4 is turned off. The first terminal of the electronic switch Q2 is at logic high. The electronic switch Q2 is turned off. The power input VCC1 thus stops supplying power to the USB connector 21.

When the USB connector 21 is connected to the external device and the power supply cannot output signals normally, the standby switch K and the electronic switch Q3 are turned on. The electronic switch Q2 is turned on. The power input VCC1 then supplies power for the USB connector 21.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power supply circuit, comprising:
a connector module to connect an external device;
a test module, wherein when the external device is connected to the connector module, the test module outputs a first signal, and when the external device is not connected to the connector module, the test module outputs a second signal;
a switch module, wherein the switch module is connected between the connector module and the test module, when the switch module receives the first signal from the test module, the switch module connects the connector module to a power supply, and when the switch module receives the second signal from the test module, the switch module disconnects the connection between the connector module and the power supply.

2. The power supply circuit of claim 1, wherein the connector comprises a first resistor, a second resistor, a third resistor, a fourth resistor, and a universal serial bus (USB) connector, the USB connector comprises a first pin, a second pin, a third pin, a fourth pin, a first shield pin, and a second shield pin, the first pin is connected to the switch module, the second pin is connected to the switch module through the fourth resistor, the second pin is grounded through the third resistor, the third pin is connected to the switch module through the first resistor, the third pin is grounded through the second resistor, the fourth pin is grounded, and the first shield pin and the second shield pin are connected to the test module.

3. The power supply circuit of claim 2, wherein the test module comprises a fifth resistor, a six resistor, a seventh resistor, a first power input, a first electronic switch, the first power input is connected to a node between the first shield pin and the second shield pin of the USB connector through the fifth resistor and the sixth resistor in that order, a node between the fifth resistor and the sixth resistor is connected to a first terminal of the first electronic switch, the first power input is connected to a second terminal of the first electronic switch through the seventh resistor, the second terminal of the first electronic switch is connected to the switch module, and a third terminal of the first electronic switch is grounded.

4. The power supply circuit of claim 3, wherein the switch module comprises an eighth resistor, a ninth resistor, a tenth resistor, an eleventh resistor, a twelfth resistor, a second electronic switch, a third electronic switch, a second power input, and the power supply, the second power input is connected to a second terminal of the second electronic switch, the second power input is connected to a second terminal of the third electronic switch through the eleventh resistor, the second terminal of the third electronic switch is connected to a first terminal of the second electronic switch through the tenth resistor, a third terminal of the second electronic switch is connected to the first pin of the USB connector, a third terminal of the third electronic switch is grounded, a first terminal of the third electronic switch is grounded through the eighth resistor, and an input of the power supply is connected to the second terminal of the first electronic switch.

5. The power supply circuit of claim 4, wherein the switch module further comprises a standby switch and a fourth electronic switch, a first terminal of the fourth electronic switch is connected to the second terminal of the first electronic switch through the standby switch, a second terminal of the fourth electronic switch is connected to the first terminal of the second electronic switch through the tenth resistor, and a third terminal of the fourth electronic switch is grounded.

6. The power supply circuit of claim 5, wherein the first electronic switch, the third electronic switch, and the fourth electronic switch are n-channel Bipolar Junction Transistors (BJTs), and the second electronic switch is a p-channel field effect transistor.
